(19) United States
(12) Patent Application Publication
(10) Pub. No.: US 2004/0158762 A1
(43) Pub. Date: Aug. 12, 2004

(54) Processes for determining nondiscriminatory access to a telecommunication network

(76) Inventor: Richard J. Abraham JR., Orlando, FL (US)

Correspondence Address: Scott P. Zimmerman, P.O. Box 3822, Cary, NC, 27519, US

(21) Appl. No.: 10/252,199

(22) Filed: Sep. 23, 2002

(51) Int. Cl. H04L 1/22

(52) U.S. Cl. 714/1

(57) ABSTRACT

A method is disclosed for determining parity in the maintenance of a telecommunication network. The process receives a report of a trouble with the telecommunications network. The report has an associated report date and report time. A technician is dispatched to repair the trouble, with the repair having an associated repair date and repair time. A time to repair is determined, and the time to repair is measured from the report date and report time to the repair date and repair time. The process compares the time to repair between a Bell operating company and another telecommunications service provider, and the time to repair helps determine that the Bell operating company is providing access to the telecommunications network.

### NOTICE OF COPYRIGHT PROTECTION

A portion of the disclosure of this patent document and its figures contain material subject to copyright protection. The copyright owner has no objection to the facsimile reproduction by anyone of the patent document or the patent disclosure, but the copyright owner otherwise reserves all copyrights whatsoever.

### BACKGROUND OF THE INVENTION

1. Field of the Invention

This invention generally relates to telecommunications and, more particularly, to processes for determining nondiscriminatory access (or “parity”) in a telecommunications network.

2. Description of the Related Art

The Telecommunications Act of 1996 permits a Bell operating company to provide long distance telephone service. See 47 U.S.C. § 271 (b)(1) (2002). Before, however, a Bell operating company may provide long distance telephone service, the Bell operating company must provide nondiscriminatory access to the network elements. See 47 U.S.C. § 251 (c)(3) (2002). If the Bell operating company is to provide nondiscriminatory access to the network elements, the Bell operating company must provide access to the company's operations support systems (OSS). A Bell operating company's OSS includes the information, systems, and personnel that support and repair the network elements and services. When the Bell operating company provides nondiscriminatory access to the company's operations support systems (OSS), a competing telecommunications service provider can order service for customers and place orders for repair and maintenance.

A Bell operating company, then, strives to provide the same timely repairs for customers of competing telecommunications service providers. When the Bell operating company quickly repairs the problems of its customers, and the problems of the customers of competing telecommunications service providers, this nondiscriminatory service demonstrates parity in maintenance, in support, and in other operations support services. This parity in operations support services assures that the local market is open to competition, and this parity in operations support services assists the Bell operating company in earning long distance service.

There is, accordingly, a need for processes that provide nondiscriminatory access to the telecommunications network, a need for processes that demonstrate when a competing telecommunications service provider has nondiscriminatory access to operations support services, and a need for processes that ensures parity in the maintenance of the telecommunications network.

### BRIEF SUMMARY OF THE INVENTION

The aforementioned problems are reduced by processes for determining nondiscriminatory access to a telecommunication network. The term “telecommunication network” includes the wires, cables, and equipment comprising a local loop. This invention ensures a competing telecommunication service provider has nondiscriminatory access to a Bell operating company's operations support services. One embodiment of this invention is a process for providing nondiscriminatory access to the telecommunications network. The process receives a report of a trouble with the telecommunications network. The report has an associated report date and report time. Authorization for delayed maintenance is received and a trouble ticket is assigned for repair of the trouble. A target date and a target time for repair of the trouble is determined, with the target date and the target time within a specified time frame. The goal is to complete each repair within this specified time frame. This specified time frame may be any amount of time, from minutes to days to weeks to months. A technician is dispatched to repair the trouble. When the trouble may not be repaired within the specified time frame, the trouble and/or the trouble ticket is reported. The process demonstrates that the Bell operating company is providing nondiscriminatory access to the telecommunications network.

The term “reported” (or “reports”) means either the Bell operating company or the competing telecommunications service provider is informed of the trouble and/or the trouble ticket. The customer, for example, may report the lack of a timely repair. The technician may report the uncompleted repair to a supervisor, a coworker, or other person responsible for receiving such reports. The uncompleted repair could even be flagged or identified by a person or by a computer program—such as when a person or a computer notices the work order is not closed, or will not be closed, within the specified time frame. The term “reported” (or “reports”) could also encompass informing a state governmental agency (such as a state utilities commission or a state attorney general) or a federal governmental agency (such as the Federal Communications Commission).

Another embodiment of this invention also describes a process for determining nondiscriminatory access to the telecommunication network. This embodiment receives a report of a trouble with the telecommunications network. The report has an associated report date and report time. A technician is dispatched to repair the trouble, with the repair having an associated repair date and repair time. A time to repair is determined, and the time to repair is measured from the report date and report time to the repair date and repair time. The process compares the time to repair between a Bell operating company and another telecommunications service provider, and this comparison demonstrates that the Bell operating company is providing nondiscriminatory access to the telecommunications network.

Yet another embodiment of this invention also describes a process for determining nondiscriminatory access to the telecommunication network. This embodiment receives reports of troubles with the telecommunications network. Technicians are dispatched to repair the troubles, and this embodiment reports when a technician does not complete a repair within a specified time frame. This embodiment then compares the number of completed repairs within the specified time frame, and the number of uncompleted repairs within that specified time frame, between a Bell operating company and a competing telecommunications service provider. The goal is to complete the repair within a specified time frame. This comparison (between the number of completed repairs and the number of uncompleted repairs) demonstrates that the Bell operating company is providing nondiscriminatory access to the telecommunications network.

When the technician does not complete a repair within the specified time frame, this uncompleted repair gets reported. The number of completed repairs, and the number of uncompleted repairs, within the specified time frame demonstrates that the Bell operating company is providing nondiscriminatory access to the telecommunications network.

### BRIEF DESCRIPTION OF THE SEVERAL VIEWS OF THE DRAWINGS

These and other features, aspects, and advantages of this invention are better understood when the following Detailed Description of the Invention is read with reference to the accompanying drawings, wherein:

FIG. 1 is a schematic illustrating one embodiment of this invention;

FIG. 2 is a flowchart showing another embodiment of this invention;

FIGS. 3 and 4 are flowcharts illustrating yet another embodiment of this invention; and

FIG. 5 is a flowchart illustrating still another embodiment of this invention.

### DETAILED DESCRIPTION OF THE INVENTION

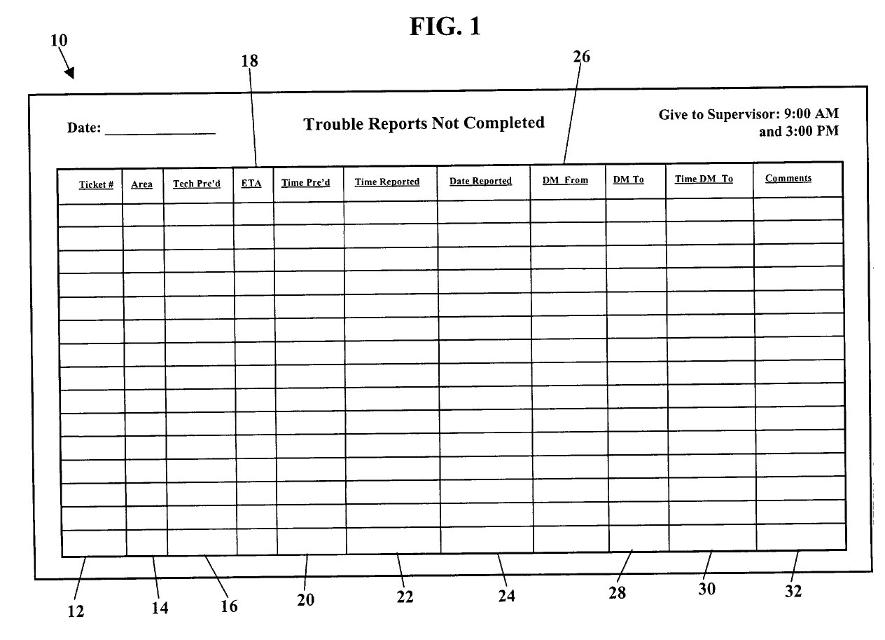

FIG. 1 shows one embodiment of this invention. FIG. 1 is a schematic illustrating a form 10 for reporting trouble within a telecommunications network. This form 10 reports when a customer's trouble may not be timely repaired. The form 10 helps ensure that timely repairs are made for customers of a Bell operating company and for customers of a competing telecommunications service provider. When a customer reports a problem with their telecommunication service, the form 10 tracks the date and the time that the trouble was reported. The form 10 also tracks the estimated date and time for repair of the customer's problem and whether the repair has been delayed. The form 10 may then be used to prioritize repair efforts to ensure all customers of the telecommunications network, whether customers of the Bell operating company or customers of a competing telecommunications service provider, receive timely repairs. Timely repairs for all customers and users of the telecommunications network may be one factor when determining parity in maintenance, in support, and in other operations support services.

As FIG. 1 shows, information is reported on the form 10 under an appropriate heading. A first column 12 tracks each repair ticket number, while a second column 14 identifies the geographic area assigned to each repair ticket. A third column 16 lists what technician has been assigned to the repair ticket. A fourth column 18 shows what time the assigned technician is estimated to arrive at the repair location, while a fifth column 20 lists what time the technician was assigned to the repair ticket. A sixth column 22 and a seventh column 24 list, respectively, the time and date that the customer initially reported the trouble.

The form 10 also shows when maintenance is delayed. The goal is to complete each repair within a specified time frame. This specified time frame may be any amount of time, from minutes to days. For this example, however, the specified time frame is assumed to be twenty-four (24) hours. When a customer calls at 3 PM to report a trouble with their telecommunications service, the goal is to complete the repair within that specified time frame (in this example, the goal is to complete the maintenance within 24 hours, or by 3 PM the next day). If, however, the customer is a business, and the business closes at 5 PM, a technician may not be able to gain access to the premises until the next business morning. A residential customer, likewise, may not be home to permit access to the customer's residence. The customer, in these cases, may authorize delayed maintenance. When the customer authorizes delayed maintenance, the time frame for completing the repair will not begin until the technician can access the customer's premises. Thus, when the business customer authorizes delayed maintenance, the specified time frame does not begin until the next business morning when the technician can access the customer's premises.

The form 10, then, also shows delayed maintenance. The form 10 includes an eighth column 26, a ninth column 28, and a tenth column 30. The eighth column 26 reports the date the customer's trouble was granted delayed maintenance. The ninth column 28 and the tenth column 30 list, respectively, the new date and time by which the customer's trouble must be repaired. An eleventh column 32 permits the addition of any comments helpful to the repair or to any entry in the row.

The form 10 is typically completed twice daily. The form 10 is completed at the beginning of a workday (such as at 9 AM each morning), and the form 10 indicates what repairs were not completed, or delayed, from the night before. The form 10 is also completed in the late afternoon (such as at 3 PM each afternoon), and the form 10 indicates what repairs may not get completed by the end of the workday. The form gives management time to coordinate additional technician resources, to reprioritize repair efforts, or to seek delayed maintenance.

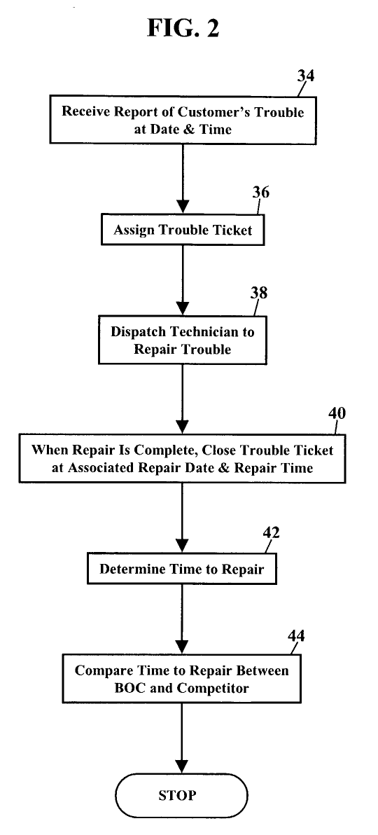

FIG. 2 is a flowchart showing another embodiment of this invention. A report is received of trouble with the telecommunications network, and that report has an associated report date and report time (Block 34). A trouble ticket (or work order) is assigned for repair of the trouble (Block 36). A technician is dispatched to repair the trouble (Block 38). When the technician completes the repair, the trouble ticket is closed and associated with a repair date and a repair time (Block 40). A time to repair is then determined (Block 42). The time to repair is measured from the report date and report time to the repair date and repair time. The time to repair is then compared between a Bell operating company (BOC) and another telecommunications service provider (Block 44). The comparison of the times to repair, between the Bell operating company and the competing telecommunications service provider, demonstrates that the Bell operating company is providing nondiscriminatory access to the telecommunications network.

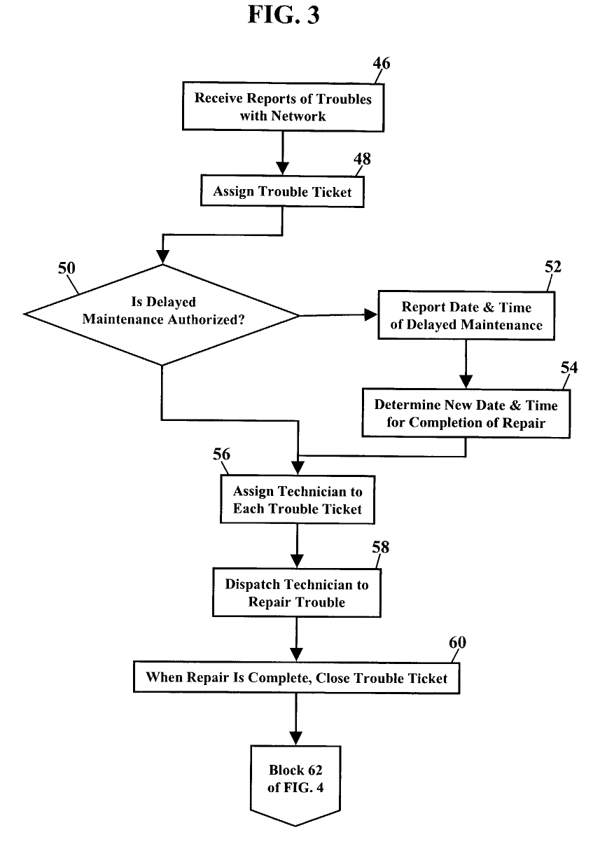

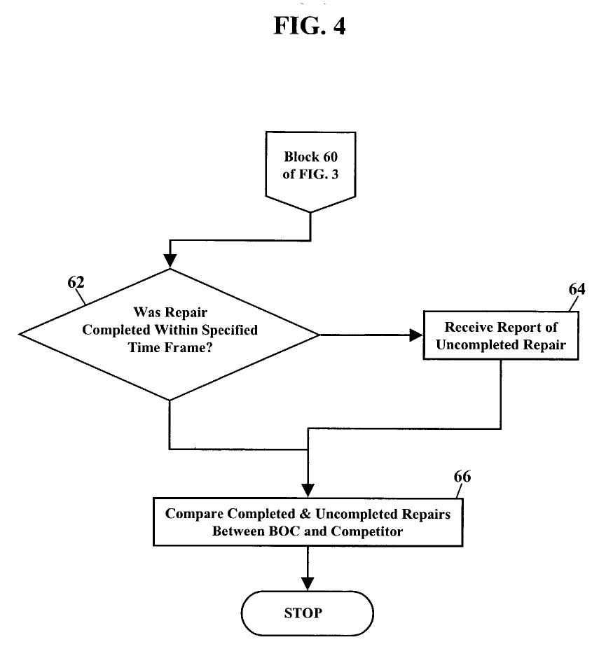

FIGS. 3 and 4 are flowcharts illustrating yet another embodiment of this invention. Reports of troubles with the telecommunications network are received (Block 46), and a trouble ticket (or work order) is assigned to each trouble (Block 48). If delayed maintenance is authorized (Block 50), the date and the time that the repair was delayed is reported (Block 52). A new date and time for completion of the delayed repair is then determined (Block 54). After one or more technicians are assigned to each trouble ticket (Block 56), the technicians are dispatched to repair the troubles (Block 58). The trouble ticket is closed when the repair is completed (Block 60).

The flowchart continues with FIG. 4. The goal, as mentioned above, is to complete the repair within a specified time frame. If the technician does not complete a repair within the specified time frame (Block 62), either the Bell operating company or to the competing telecommunications service provider receives a report of this uncompleted repair (Block 64). The customer, for example, may report the lack of a timely repair. The technician may report the uncompleted repair to a supervisor, a coworker, or other person responsible for receiving such reports. The uncompleted repair could even be flagged or identified by a person or by a computer program—such as when the work order is not closed within the specified time frame. This uncompleted repair could additionally or alternatively be reported to a state governmental agency (such as a state utilities commission or to a state attorney general) or to a federal governmental agency (such as the Federal Communications Commission). This process then compares (Block 66) the number of completed repairs within the specified time frame, and the number of uncompleted repairs, between a Bell operating company (BOC) and another telecommunications service provider. The comparison between the number of completed repairs, and the number of uncompleted repairs, demonstrates that the Bell operating company is providing nondiscriminatory access to the telecommunications network.

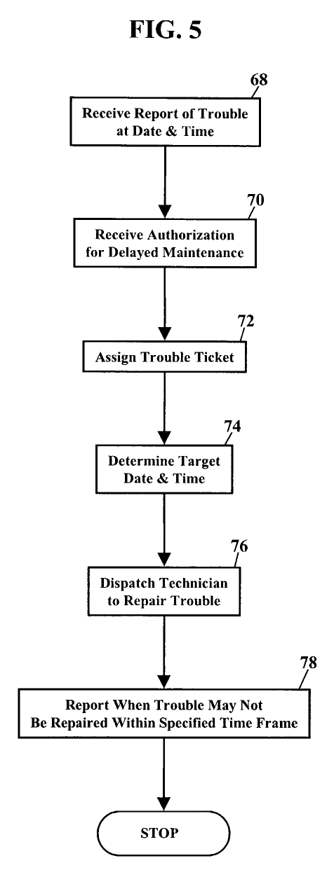

FIG. 5 is a flowchart illustrating still another embodiment of this invention. This embodiment is yet another process for providing nondiscriminatory access to the telecommunications network. This process receives a report of a trouble with the telecommunications network (Block 68). The report has an associated report date and report time. Authorization for delayed maintenance is received (Block 70) and a trouble ticket is assigned for repair of the trouble (Block 72). A target date and a target time for repair of the trouble is determined (Block 74), with the target date and the target time within a specified time frame. The goal is to complete each repair within this specified time frame. This specified time frame may be any amount of time, from minutes to days. A technician is dispatched to repair the trouble (Block 76). When the trouble may not be repaired within the specified time frame, the trouble and/or the trouble ticket is reported (Block 78). The process ensures that repairs are completed within the specified time frame, thus demonstrating that the Bell operating company is providing nondiscriminatory access to the telecommunications network.

The embodiments of this invention may be implemented by computer programming. An Integrated Dispatch System, for example, comprises computer programs and computer systems that manage the dispatch of work orders in a telecommunications network. The Integrated Dispatch System already gathers much of the information required for the processes of this invention. The Integrated Dispatch System is more thoroughly discussed in U.S. application Ser. No. 10/175,123, filed Jun. 19, 2002, entitled “Validating Turfs for Work Orders,” of which the “Summary of the Invention” and the “Detailed Description of the Invention” sections are incorporated herein by reference. The Integrated Dispatch System could incorporate the processes of this invention and, thus, help determine that the Bell operating company is providing nondiscriminatory access to the telecommunications network.

The embodiments of this invention may be implemented in a computerized technician access system. Many technicians, for example, have a wireless computer for accessing customer service information and network status information. The processes of this invention could be integrated into these technician computers, thus allowing the technicians to immediately report when a repair will not be completed. The computerized technician access system could also report to other computer systems, such as the Integrated Dispatch System, when the repair will not be completed within the specified time frame. The Integrated Dispatch System, for example, could then reassign the repair to another technician in the hopes of completing the repair within the specified time frame.

The processes of this invention may be physically embodied on or in a computer-readable medium. This computer-readable medium may include CD-ROM, DVD, tape, cassette, floppy disk, memory card, and large-capacity disk (such as IOMEGA®, ZIP®, JAZZ®, and other large-capacity memory products (IOMEGA®, ZIP®, and JAZZ® are registered trademarks of lomega Corporation, 1821 W. Iomega Way, Roy, Utah 84067, 801.332.1000, www.iomega.com). This computer-readable medium, or media, could be distributed to end-users, licensees, and assignees. These types of computer-readable media, and other types not mention here but considered within the scope of the this invention, allow the processes of this invention to be easily disseminated. A computer program product, for determining nondiscriminatory access to the telecommunications network, comprises the computer-readable medium and the processes of this invention. The processes of this invention are stored on the computer-readable medium.

While the present invention has been described with respect to various features, aspects, and embodiments, those skilled and unskilled in the art will recognize the invention is not so limited. Other variations, modifications, and alternative embodiments may be made without departing from the spirit and scope of the present invention.

What is claimed is:

1. A process, comprising:
receiving a report of a trouble with a telecommunications network, the report having an associated report date and an associated report time;
dispatching a technician to repair the trouble, the repair having an associated repair date and an associated repair time;
determining a time to repair, the time to repair measured from the report date and report time to the repair date and repair time; and
comparing the time to repair between a Bell operating company and another telecommunications service provider,
wherein the time to repair helps determine that the Bell operating company is providing access to the telecommunications network.

2. A process according to claim 1, further comprising assigning a work order for repair of the trouble.

3. A process according to claim 2, further comprising closing the work order when the repair is complete.

4. A process, comprising:
receiving reports of troubles with a telecommunications network;
dispatching technicians to repair the troubles;
reporting when a technician does not complete a repair within a specified time frame; and
comparing the number of completed repairs and the number of uncompleted repairs between a Bell operating company and another telecommunications service provider,
wherein the number of completed repairs and the number of uncompleted repairs demonstrates that the Bell operating company is providing access to the telecommunications network.

5. A process according to claim 4, further comprising assigning a work order to a trouble.

6. A process according to claim 5, further comprising assigning the technician to the work order.

7. A process according to claim 4, further comprising delaying a repair of a trouble.

8. A process according to claim 7, further comprising reporting a date that the repair was delayed.

9. A process according to claim 7, further comprising reporting a time that the repair was delayed.

10. A process according to claim 7, further comprising reporting a target date for completion of the delayed repair.

11. A process according to claim 7, further comprising reporting a target time for completion of the delayed repair.

12. A process according to claim 4, further comprising closing the work order when the repair is complete.

13. A process, comprising:
receiving a report of a trouble with a telecommunications network, the report having an associated report date and report time;
receiving authorization for delayed maintenance;
determining a target date and a target time for repair of the trouble, the target date and the target time within a specified time frame;
dispatching a technician to repair the trouble; and
reporting when the trouble may not be repaired within the specified time frame,
wherein the process demonstrates that the Bell operating company is providing nondiscriminatory access to the telecommunications network.
